(19) United States
(12) Patent Application Publication
(10) Pub. No.: US 2018/0009209 A1
(43) Pub. Date: Jan. 11, 2018

(54) COVER TAPE AND METHOD FOR MANUFACTURING THE SAME

(71) Applicant: Kenner Material & System Co., Ltd., Taoyuan City (TW)

(72) Inventors: Hung-Wei Pan, Taoyuan City (TW); Li-Sheng Hsu, Taoyuan City (TW); Chin-Huei Yen, Taoyuan City (TW)

(21) Appl. No.: 15/631,645

(22) Filed: Jun. 23, 2017

(30) Foreign Application Priority Data
Jul. 6, 2016 (TW) 105121469

(51) Int. Cl. B32B 37/15; B32B 7/14; B29C 45/16; B32B 27/08

(52) U.S. Cl. CPC B32B 37/153; B32B 7/14; B29C 45/1657; B32B 27/08

(57) ABSTRACT

The invention provides a cover tape and the method for manufacturing the same. The cover tape comprises an antistatic layer, two intermediate layers, a base layer, two tie layers and a heat seal layer. These seven layers are formed by a co-extrusion process.

### CROSS-REFERENCE TO RELATED APPLICATIONS

The entire contents of Taiwan Patent Application No. 105121469, filed on Jul. 6, 2016, from which this application claims priority, are expressly incorporated herein by reference.

### BACKGROUND OF THE INVENTION

### 1. Field of the Invention

The present invention relates to a cover tape and its producing method, and more particularly, relates a multi-layered cover tape made by a co-extrusion process.

### 2. Description of Related Art

Electronic components, such as integrated circuit chips, are collected and transport by a carrier tape before they are mounted on a printed circuit board. The carrier tape includes a plurality of pockets to receive the electronic components. The electronic components are sealed within the pockets or recesses of the carrier tape by a cover tape and a heat-sealing method. When the electronic components and the printed circuit board are being assembled, the cover tape is firstly peeled off, then an automatic equipment, such as a robotic arm, is used to take the electronic components out of the carrier tape one by one along the carrier tape and then to arrange them on predetermined positions of the printed circuit board.

Typically, the transmittance of the cover tape is needed to be sufficiently high so that the sealed electronic components within the carrier tape can be inspected. In addition, the cover tape also should be antistatic to protect the electronic components being damaged from electrostatic charges.

A conventional cover tape typically includes a base layer, a middle layer, a peeling layer, and a heat-sealing layer. Both the base layer and the heat-sealing layer generally are coated with anti-static materials. The base layer typically is made of polyethylene terephthalate (PET), and the heat-sealing layer is made of acrylic resins. The middle layer, the peeling layer, and the heat-sealing layer are separately formed and then applied to the base layer by adhesives or bonding layers using coating or lamination process. Typically a co-extrusion process is merely applied to the base layer or the middle layer of the cover tape. Other functional layers, including the heat-sealing layer and the antistatic layer, are applied to the base layer by coating or lamination process. Accordingly, the conventional manufacturing procedure of the cover tape include multiple and complex steps.

The present invention therefore provides a new cover tape and its manufacturing process, wherein the new cover tape at least includes a base layer, a middle layer, and a heat-sealing layer, and the layers of the cover tape are integrally formed by a direct co-extrusion process, so that the complicated steps of the conventional cover tapes can be simplified.

### SUMMARY OF THE INVENTION

In one general aspect, the present invention relates to a cover tape and its producing method, and more particularly, relates a multi-layered cover tape made by a co-extrusion process.

In an embodiment of the present invention, a cover tape is provided with: an antistatic layer to provide an antistatic property; a first intermediate layer below the antistatic layer; a first tie layer below the first intermediate layer; a base layer below the first tie layer; a second tie layer below the base layer; a second intermediate layer below the second tie layer; and a heat-sealing layer below the second intermediate layer; wherein the antistatic layer, the first intermediate layer, the first tie layer, the base layer, the second tie layer, the second intermediate layer, and the heat-sealing layer are formed by a co-extrusion process.

In an embodiment of the present invention, a method for manufacturing a cover tape is provided with the steps of: providing materials for forming a multi-layer including an antistatic layer, a first intermediate layer, a first tie layer, a base layer, a second tie layer, a second intermediate layer, and a heat-sealing layer; providing extruders with each extruder corresponding one of the multi-layer and being fed with the material for forming the corresponding layer and being set at processing temperature for the material in a predetermined order; and simultaneously heating the material within each extruder to extrude corresponding single-layered molten film; melting and flattening the single-layered molten films to form a multi-layered film consisting of the antistatic layer, the first intermediate layer, the first tie layer, the base layer, the second tie layer, the second intermediate layer, and the heat-sealing layer.

In an embodiment of the present invention, a method for manufacturing a cover tape is provided with the steps of: providing materials for forming a multi-layer including an antistatic layer, a first intermediate layer, a first tie layer, a base layer, a second tie layer, a second intermediate layer, and a heat-sealing layer; providing seven extruders with each extruder corresponding one of the multi-layer and being fed with the material for forming the corresponding layer and being set at the processing temperature for the material in a predetermined order of the antistatic layer, the first intermediate layer, the first tie layer, the base layer, the second tie layer, the second intermediate layer, and the heat-sealing layer; and co-extruding the material within each extruder to form the cover tape.

### BRIEF DESCRIPTION OF THE DRAWINGS

FIG. 1 is a cross-sectional view showing a cover tape according to an embodiment of the present invention.

FIG. 2 is flow chart showing a method for manufacturing a cover tape according to an embodiment of the present invention.

### DETAILED DESCRIPTION OF THE PREFERRED EMBODIMENT

Embodiments of the invention are now described and illustrated in the accompanying drawings. In certain aspects, use of like or the same reference designators in the drawings and description refers to the same, similar or analogous components and/or elements, while according to other implementations the same use should not. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention. While drawings are illustrated in detail, it is appreciated that the quantity of the disclosed components may be greater or less than that disclosed, except where expressly restricting the amount of the components.

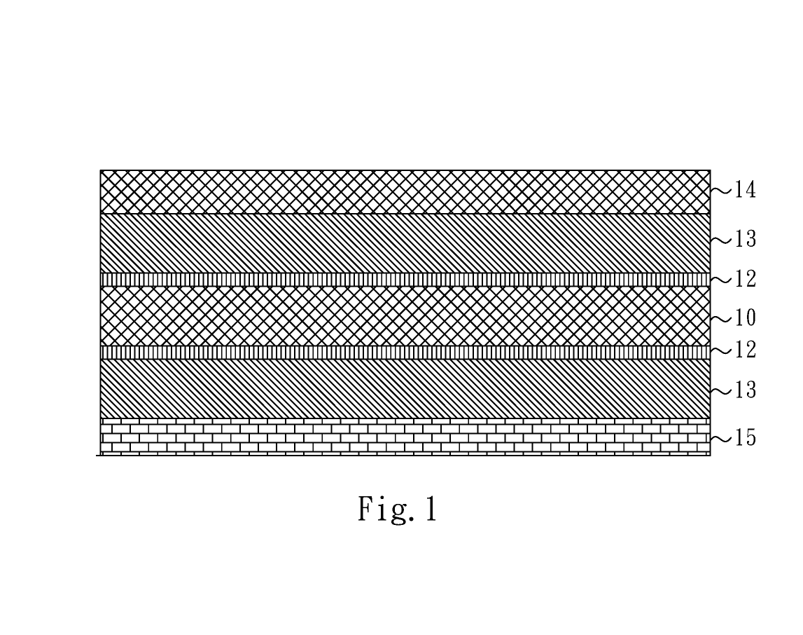

FIG. 1 is a cross-sectional view showing a cover tape according to a first embodiment of the present invention. In this preferred embodiment, the cover tape at least includes a base layer 10, two tie layers 12, two intermediate layers 13, an antistatic layer 14, and a heat-sealing layer 15. The two tie layers are used to couple with the base layer 10 and one corresponded intermediate layer 13, respectively. The antistatic layer 14 can reduce or eliminate buildup of static charges. The heat-sealing layer 15 is used to seal the cover tape with a carrier tape, and it also can reduce or eliminate buildup of static charges. As shown in FIG. 1, the layers are arranged in an order from top to bottom as follows: the antistatic layer 14, one intermediate layer 13, one tie layer 12, the base layer 10, one tie layer 12, one intermediate layer 13, and the heat-sealing layer 15. The arrangement of the layers shown in FIG. 1 is preferred but it should not be limited. In other embodiments of the present invention, the cover tape may have other arrangements different from FIG. 1, as long as both the heat-sealing layer and antistatic layer are antistatic and the layers of the cover tape are simultaneously formed by a co-extrusion process. Comparing with conventional cover tapes made of coating and lamination, all layers of the cover tape of the present invention are simultaneously formed by the co-extrusion process, such that the layers of the cover tape are stuck one another with a melting state, and after cooling down the cover tape will have a film configuration with a thickness within a range from 40 μm to 70 μm.

In one embodiment of the present invention, the base layer 10 is made of, but is not limited to, polyamide 6, polyamide 66, polyamide 6/polyamide 66 copolymer, or polyethylene terephthalate. The intermediate layer 13 is made of, but is not limited to, polyolefin such as polyethylene, high density polyethylene and low density polyethylene, polypropylene, or polypropylene copolymer.

In addition, each tie layer 12 is used to couple with the base layer 10 and one of the two intermediate layers 13, and it is made of, but is not limited to, Poly(ethylene-graft-maleic anhydride), Poly(propylene-graft-maleic anhydride), or polyolefin such as linear low density polyethylene, high density polyethylene and low density polyethylene, polypropylene, or polypropylene copolymer.

In addition, the antistatic layer 14 is made of or comprises, but is not limited to, polyolefin and antistatic agent including antistatic polymers, antistatic ions, and carbon nanotube. The weight ratio of the antistatic agent to the antistatic layer is about 15-30 wt %, so that both surface of the antistatic layer have a surface resistance within a range from 1.0 E+9Ω to 9.0 E+11Ω. The surface resistance is measured by standard test method ASTM D257 and measured at relative humidity (RH) 50% and temperature 23° C.

The heat-sealing layer 15 is made of or comprises, but is not limited to, antistatic agent, tackifier (hydrogenated petroleum resin), thermoplastic elastomer, acrylic resins, and mineral oil. The antistatic agent includes antistatic polymers, and the weight ratio of the antistatic agent to the heat-sealing layer is about 15-30 wt %, so that both surface of the heat-sealing layer have a surface resistance within a range from 1.0 E+9Ω to 9.0 E+11Ω. The surface resistance is also measured by standard test method ASTM D257 for DC resistance or conductance of insulating materials and measured at relative humidity (RH) 50% and temperature 23° C.

The layers shown in FIG. 1 may have other arrangements, as long as both surface of the heat-sealing layer and the antistatic layer are antistatic and all layers of the cover tape are simultaneously formed by the co-extrusion process. In an embodiment of the present invention, the manufacturing method of the cover tape includes the steps of: providing materials for the base layer 10, the two tie layers 12, the two intermediate layers 13, the antistatic layers 14, and the heat-sealing layer 15; and simultaneously co-extruding to form a single film consisting of the base layer 10, the two tie layers 12, the two intermediate layers 13, the antistatic layers 14, and the heat-sealing layer 15. Accordingly, the base layer 10 and the functional layers are simultaneously formed by the co-extrusion process. Compared with conventional cover tapes, none of layers of the cover tape of the present invention is made by coating or lamination process.

In an embodiment of the present invention, the base layer 10 is made by blending the polyamide 6 and polyamide 66, and the weight ratio of polyamide 6 to polyamide 66 is within a range 20-80 wt %.

In the embodiment of the present invention, the two intermediate layers 13 are made of linear low density polyethylene.

In the embodiment of the present invention, the tie layers 12 comprise or are made by blending Poly(ethylene-graft-maleic anhydride) and linear low density polyethylene, wherein the weight ratio of Poly(ethylene-graft-maleic anhydride) is within a range 20-40 wt %, and the weight ratio of linear low density polyethylene is within a range 80-60 wt %.

In the embodiment of the present invention, the antistatic layer 14 comprises or is made by blending antistatic polymer and linear low density polyethylene, wherein the weight ratio of antistatic polymer to linear low density polyethylene is 1:5, and at least an antioxidant, an anti-blocking agent (to avoid blocking with the heat-sealing layer during the manufacturing procedure), and an internal lubricant are added to the mixture of the antistatic polymer and linear low density polyethylene. A twin screw extruder is used to granulate the mixture, and the granules are dried at 90° C. for use later.

In the embodiment of the present invention, the heat-sealing layer 15 comprises or is made by blending at least an antistatic polymer, a tackifier, an acrylic resin, a thermoplastic elastomer, and a mineral oil. The weight ratio of the antistatic polymer, the tackifier, the acrylic resin, the thermoplastic elastomer, and the mineral oil is (10-20): (10-20): (20-30): (35-45): (5-10). In addition, at least an antioxidant, an anti-blocking agent (to avoid blocking with the heat-sealing layer during the manufacturing procedure), and an internal lubricant are added to the above mixture. A twin screw extruder is used to granulate the mixture, and the granules are dried at 90° C. for use later.

Finally, a co-extrusion machine is to blow a film of the totally seven layers including the base layer 10, two intermediate layers 13, the two tie layers 12, the antistatic layer 14, and the heat-sealing layer 15. Seven extruders (not shown) are arranged in an order respectively corresponding to the seven layers: the antistatic layer, the intermediate layer, the tie layer, the base layer, the tie layer, the intermediate layer, and the heat-sealing layer. The seven extruders comprise, but are not limited to, single screw extruders. Each extruder is set at a temperature suitable for processing the material of the layer corresponding to the extruder. The material in each extruder is gradually melted, and the seven molten polymers then flow into a circular seven-layer screw die to form a seven-layered cylindrical molten film, which then be melted to a tubular film at the outlet of the screw die. A haul device is used to draw the tubular film and air is introduced in the screw die to blow the tubular film, and the diameter of the tubular film is then increased. The rollers of the haul device are to flatten the tubular film to a flat film (two pieces). After cooling the flat film is slit into two separated pieces of film, and each single piece film can be cut to obtain desired length and width.

The thickness of the produced (single piece) film is controlled by the air cooling. Each film has a width about 1200 mm and a length about 3200 mm, and a total thickness of the film is within a range between 40 and 70 μm. The thickness of the base layer 10 is about 25-30% of the total thickness, the sum of the thickness of the two tie layers 12 is about 8-10% of the total thickness, the sum of the thickness of the two intermediate layers 13 is about 25-30% of the total thickness, the thickness of the antistatic layer 14 is about 10-12% of the total thickness, and the thickness of the heat-sealing layer 15 is about 20-25% of the total thickness.

The manufacturing method as mentioned above is not limited to the layers with an arrangement as shown in FIG. 1. The manufacturing method can be applied to the layers having other arrangements, as long as both surface of the heat-sealing layer and the antistatic layer are antistatic and all layers of the cover tape are simultaneously formed by the co-extrusion process.

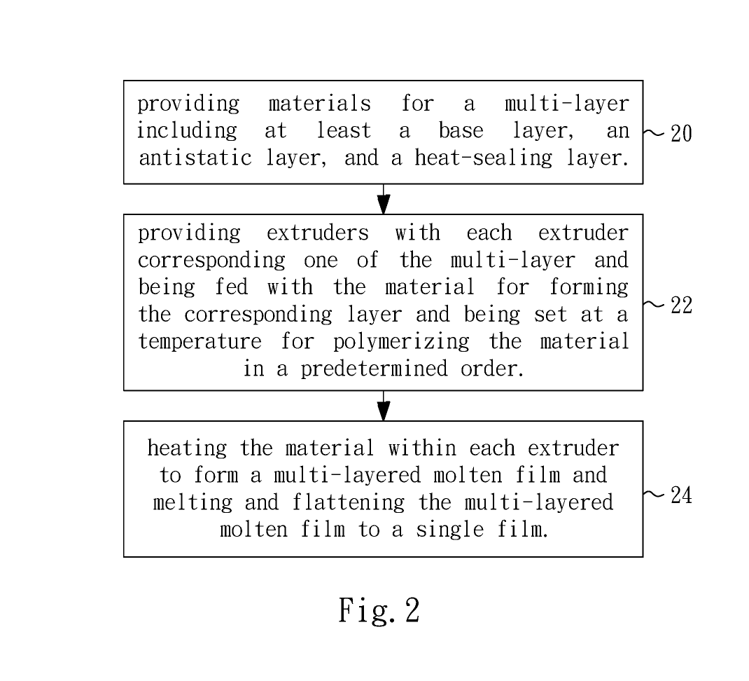

FIG. 2 is a flow chart showing a manufacturing method according to an embodiment of the present invention. The manufacturing method comprises the steps of: step 20, providing materials for a multi-layer including at least a base layer, an antistatic layer, and a heat-sealing layer; step 22, providing extruders with each extruder corresponding one of the multi-layer and being fed with the material for forming the corresponding layer and being set at a temperature for processing the material in a predetermined order; step 24, heating the material within each extruder to form a multi-layered molten film and melting and flattening the multi-layered molten film to a single film. In the preferred embodiment, the materials are provided to form a base layer, two intermediate layers, two tie layers, an antistatic layer, and a heat-sealing layer with an order as shown in FIG. 1.

Compared with conventional art, the present invention provides cover tape and its manufacturing method featuring in that both surface of the heat-sealing layer and the antistatic layer are antistatic and all layers of the cover tape are simultaneously formed by a co-extrusion process. Conventional method needs complicated steps to coating or laminating materials on the base substrate for forming different functional layers such as the antistatic layer or the heat-sealing layer. By contrast, the method of the present invention co-extrudes the materials for forming the functional layers and the base layer in the meantime, so that no further surface treatment is needed.

The intent accompanying this disclosure is to have each/all embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention.

Conditional language, such as, among others, “can,” “could,” “might,” or “may,” unless specifically stated otherwise, or otherwise understood within the context as used, is generally intended to convey that embodiments include, and in other interpretations do not include, certain features, elements and/or steps. Thus, such conditional language is not generally intended to imply that features, elements and/or steps are in any way required for one or more embodiments, or interpretations thereof, or that one or more embodiments necessarily include logic for deciding, with or without user input or prompting, whether these features, elements and/or steps are included or are to be performed in any particular embodiment.

All of the contents of the preceding documents are incorporated herein by reference in their entireties. Although the disclosure herein refers to certain illustrated embodiments, it is to be understood that these embodiments have been presented by way of example rather than limitation. For example, any of the particulars or features set out or referenced herein, or other features, including method steps and techniques, may be used with any other structure(s) and process described or referenced herein, in whole or in part, in any combination or permutation as a non-equivalent, separate, non-interchangeable aspect of this invention. Corresponding or related structure and methods specifically contemplated and disclosed herein as part of this invention, to the extent not mutually inconsistent as will be apparent from the context, this specification, and the knowledge of one skilled in the art, including, modifications thereto, which may be, in whole or in part, (i) operable and/or constructed with, (ii) modified by one skilled in the art to be operable and/or constructed with, and/or (iii) implemented/made/used with or in combination with, any parts of the present invention according to this disclosure, include: (I) any one or more parts of the above disclosed or referenced structure and methods and/or (II) subject matter of any one or more of the inventive concepts set forth herein and parts thereof, in any permutation and/or combination, include the subject matter of any one or more of the mentioned features and aspects, in any permutation and/or combination.

Although specific embodiments have been illustrated and described, it will be appreciated by those skilled in the art that various modifications may be made without departing from the scope of the present invention, which is intended to be limited solely by the appended claims.

What is claimed is:

1. A method for manufacturing a cover tape, comprising the steps of:
providing materials for forming a multi-layer film including an antistatic layer, a first intermediate layer, a first tie layer, a base layer, a second tie layer, a second intermediate layer, and a heat-sealing layer;
providing extruders with each extruder corresponding one of the multi-layer and being fed with the material for forming the corresponding layer; and
simultaneously heating the material within each extruder to form a single-layered molten film, melting and flattening the single layered molten films to a multi-layered film.

2. The method as recited in claim 1, wherein the material for forming the antistatic layer comprises antistatic agent and linear low density polyethylene, the antistatic agent includes antistatic polymers, antistatic ions, or carbon nanotube, and the weight ratio of antistatic agent is 15-30 wt %.

3. The method as recited in claim 1, wherein the material for forming the first intermediate layer and the second intermediate layer comprises polyethylene, high density polyethylene and low density polyethylene, polypropylene, or polypropylene copolymer.

4. The method as recited in claim 1, wherein the material for forming the base layer comprises blending polyamide 6, polyamide 6/polyamide 66 copolymer, or polyethylene terephthalate, and the weight ratio of polyamide 6 is within a range 20-80 wt %.

5. The method as recited in claim 1, wherein the material for forming the first tie layer and the second tie layer comprises blending poly(ethylene-graft-maleic anhydride) and linear low density polyethylene, and wherein the weight ratio of poly(ethylene-graft-maleic anhydride) is within a range 20-40 wt %, and the weight ratio of linear low density polyethylene is within a range 80-60 wt %.

6. The method as recited in claim 1, wherein the material for forming the heat-sealing layer comprises blending an antistatic agent, a tackifier, an acrylic resin, a thermoplastic elastomer, and a mineral oil, and the weight ratio of the antistatic agent, the tackifier, the acrylic resin, the thermoplastic elastomer, and the mineral oil is (10-20): (10-20): (20-30): (35-45): (5-10), and wherein an antioxidant, an anti-blocking agent, and an internal lubricant are added to the blending mixture, and a twin screw extruder is used to granulate the blending mixture.

7. The method as recited in claim 1, wherein the co-extruding step comprises heating the material within each extruder to form a single-layered molten film, and melting single-layered molten films to a single tubular film consisting of the antistatic layer, the first intermediate layer, the first tie layer, the base layer, the second tie layer, the second intermediate layer, and the heat-sealing layer.

8. A cover tape, comprising:
an antistatic layer to provide an antistatic property;
a first intermediate layer below the antistatic layer;
a first tie layer below the first intermediate layer;
a base layer below the first tie layer;
a second tie layer below the base layer;
a second intermediate layer below the second tie layer; and
a heat-sealing layer below the second intermediate layer.

9. The cover tape as recited in claim 8, wherein the antistatic layer is made of an antistatic agent and polyolefin, and the weight ratio of antistatic polymer to polyolefin is 15-30 wt %, and the antistatic agent includes antistatic polymers, antistatic ions, or carbon nanotube.

10. The cover tape as recited in claim 8, wherein the heat-sealing layer is made of an antistatic agent, hydrogenated petroleum resin, thermoplastic elastomer, acrylic resins, and mineral oil, the antistatic agent includes antistatic polymers, antistatic ions, or carbon nanotube, and the weight ratio of antistatic polymer is 15-30 wt %.

11. The cover tape as recited in claim 8, wherein the base layer is made of polyamide 6, polyamide 66, polyamide 6/polyamide 66 copolymer, or polyethylene terephthalate.

12. The cover tape as recited in claim 8, wherein the first intermediate layer and the second intermediate layer is made of polyolefin, and the first tie layer and the second tie layer is made of Poly(ethylene-graft-maleic anhydride), Poly(propylene-graft-maleic anhydride), or polyolefin.

13. The cover tape as recited in claim 8, wherein the cover tape has a total thickness, the thickness of the base layer is 25-30% of the total thickness, the sum of the thickness of the first tie layer and the second tie layer is 8-10% of the total thickness, the sum of the thickness of the first intermediate layer and the second intermediate layer is 25-30% of the total thickness, the thickness of the antistatic layer is 10-12% of the total thickness, and the thickness of the heat-sealing layer is about 20-25% of the total thickness.
